(19) United States
(12) Patent Application Publication
(10) Pub. No.: US 2008/0101823 A1
(43) Pub. Date: May 1, 2008

(54) DEVELOPING DEVICE, PROCESS CARTRIDGE AND IMAGE FORMING APPARATUS

(76) Inventors: Hiroaki Katoh, Nagaokakyo-city (JP); Shuuichi Nakagawa, Osaka (JP); Masayuki Hagi, Osaka (JP); Takuya Kadota, Kobe-city (JP); Yoshihiro Mikuriya, Nishinomiya-city (JP); Katsunori Kurose, Takarazuka-city (JP); Atsushi Yamamoto, Kawanishi-city (JP); Masahide Inoue, Numazu-city (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/924,994

(22) Filed: Oct. 26, 2007

(30) Foreign Application Priority Data
Oct. 31, 2006 (JP) 2006-295955

(51) Int. Cl. G03G 15/08

(52) U.S. Cl. 399/284

(57) ABSTRACT

A developing device is provided including a developer bearing member configured in close proximity to or contacting the surface of the photosensitive member, a developer supplying member arranged in a developer supplying section and configured to supply the surface of the photosensitive member with developer, a developer storing section arranged above the developer supplying section to store the developer, an inlet arranged above the developer supplying member through which developer is transferred from the developer storing section to the developer supplying section, and a developer regulating member configured to regulate the thickness of the developer on the surface of the developer bearing member, wherein no portion of the inlet is overlaps the regulating member in the vertical direction.

### CROSS-REFERENCE TO RELATED APPLICATIONS

The present application claims priority from Japanese Patent Application No. 2006-295955, filed in the Japan Patent Office on Oct. 31, 2006, the disclosure of which is incorporated by reference herein in its entirety.

### BACKGROUND OF THE INVENTION

1. Field of the Invention

The present invention relates to a developing device, and an image forming apparatus and a process cartridge that includes the developing device, and more particularly to a developing device, an image forming apparatus and a process cartridge including monocomponent toners.

2. Discussion of the Background

Recently, tandem image forming apparatuses have been in wide use. The tandem image forming apparatus includes a plurality of process cartridges, which form the respective color toner images.

The color toner images on the surface of the photosensitive drums are transferred to a transfer media, one after another.

The process cartridge includes a photosensitive drum on which an electrostatic latent image is formed, a charging roller that charges the surface of the photosensitive drum, a developing device that develops the electrostatic latent image by supplying toner, and a cleaning device that removes residual toner remaining on the surface of the photosensitive member after transferring.

The developing device includes a developing roller that contacts the surface of the photosensitive drum and supplies the photosensitive member with toner, a supplying roller that contacts the developing roller, a toner regulating member and a toner storaging section that stores toner. When the tandem image forming apparatus includes a plurality of the process cartridges arranged linearly, there is a problem that the size of the tandem image forming apparatus grows in the direction where the process cartridges line up.

To eliminate the above-mentioned problem, an image forming apparatus has been proposed. In the proposed image forming apparatus, the toner storage section of the developing device is arranged above the developing roller and the toner regulating member to shorten the interval of each process cartridge.

Japanese Laid-Open Patent Publication No. 2004-219507 shows a tandem image forming apparatus including four process cartridges. The process cartridge has a toner storage section arranged above a drum unit. However, the toner storage section is arranged just above a toner regulating member and a toner supplying roller. Therefore, the flow of toner in a neighborhood of the toner regulating member and the supplying roller is restrained by gravity of toner of the toner storage section. As a result, toner is not uniformly supplied on the surface of the developing roller, and a toner layer thickness irregularity and poor image density occurs.

Thus, the toner, which repeatedly by passes a nip between the toner regulating member and the developing roller, is accumulated in an end abutment neighborhood of the toner regulating member. Thus, the deteriorated toner is agglomerated and adhered, and a problem including a streak in the image is caused.

### SUMMARY OF THE INVENTION

The present invention can overcome one or more of the above-noted disadvantages. An object of the present invention is to provide a developing device that develops latent images on a surface of a photosensitive member in an image forming apparatus, the developing device including a developer bearing member arranged in close proximity to or contacting the surface of the photosensitive member, a developer supplying member arranged in a developer supplying section and configured to supply the surface of the photosensitive member with the developer, a developer storing section arranged above the developer supplying section and configured to store the developer, an inlet, arranged above the developer supplying member, through which developer is transferred from the developer storaging section to the developer supplying section, and a developer regulating member configured to regulate the thickness of the developer on the surface of the developer bearing member, wherein no portion of the inlet overlaps the regulating member in the vertical direction.

An another object of the present invention is to provide a process cartridge configured to be detachably mounted in an image forming apparatus, including a developing device that develops latent images on a surface of a photosensitive member, a developer bearing member arranged in close proximity to or contacting the surface of the photosensitive member, a developer supplying member arranged in a developer supplying section and configured to supply the surface of the photosensitive member with the developer, a developer storaging section arranged above the developer supplying section and configured to store the developer, an inlet arranged above the developer supplying member, through which the developer is transferred from the developer storing section to the developer supplying section, and a developer regulating member configured to regulate the thickness of the developer on the surface of the developer bearing member, wherein no portion of the inlet overlaps the regulating member in the vertical direction.

A further object of the present invention is to provide an image forming apparatus, including a developing device that develops latent images on a surface of a photosensitive member, a developer bearing member arranged in close proximity to or contacting the surface of the photosensitive member, a developer supplying member arranged in a developer supplying section and configured to supply the surface of the photosensitive member with the developer, a developer storing section arranged above the developer supplying section and configured to store the developer, an inlet, arranged above the developer supplying member, through which developer is transferred from the developer storing section to the developer supplying section, and a developer regulating member configured to regulate the thickness of the developer on the surface of the developer bearing member, wherein no portion of the inlet overlaps the regulating member in a vertical direction.

These and other objects, features and advantages of the present invention will become apparent upon consideration of the following description of the preferred embodiments of the present invention taken in conjunction with the accompanying drawings.

### BRIEF DESCRIPTION OF THE DRAWING

The accompanying drawings, which are incorporated in and constitute a part of the specification, illustrate the invention, and, together with the description, serve to explain the principles of the invention.

FIG. 1 is a schematic view of an image forming apparatus according to an exemplary embodiment of the present invention.

FIG. 2 is a sectional view of a process unit included in the image forming apparatus shown in FIG. 1.

FIG. 3 is a structural diagram of the charge controlling agents.

### DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present invention are described.

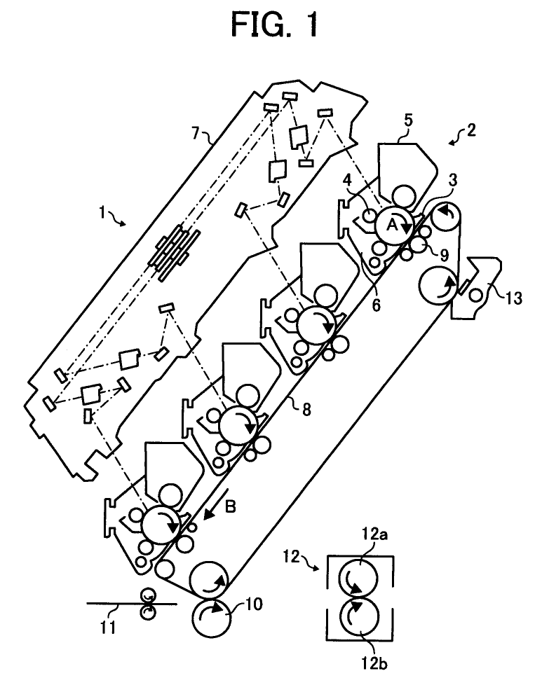

Referring to FIG. 1, a structure of a tandem type color image forming apparatus is shown as an example of an image forming apparatus according to an exemplary embodiment of the present invention.

As illustrated in FIG. 1, the image forming apparatus 1 includes four process cartridges 2.

Each process cartridge 2 integrally includes a photosensitive drum 3, serving as a image carrying member, a charge roller 4, a developing device 5 and a cleaning device 6, respectively. Each process cartridge includes a different color developer in the developing device 5, respectively. The four process cartridges 2 are arranged along an intermediate transferring belt 8. The color of the developer in the process cartridges 4 are yellow, cyan, magenta, and black in the moving direction of the intermediate transferring belt 8.

The process cartridges 2 are detachable from a body of the image forming apparatus 1.

The photosensitive drum 3 is rotated at a circumferential speed of 150 mm/sec in a direction of arrow A illustrated in FIG. 1 by a rotating source (not shown).

The charging roller 4 contacts the circumference of the photosensitive drum 3, and rotates with the photosensitive drum 3.

The charge roller 4 is applied a predetermined bias by a power source (not shown), and charges the surface of the photosensitive member 3, e.g., with a charge of −500 V.

An optical writing device 7 is arranged to form an electric latent image on the surface of the photosensitive drum.

For the optical writing device 7, a laser beam scanner including a laser diode or an LED are used.

The developing device 5 includes monocomponent toner, and the developing device 5 is applied a predetermined bias by a power source (not shown).

The developing device 5 develops the electrostatic latent image on the surface of the photosensitive drum 3.

The cleaning device 6 removes residual toner remaining on the surface of the photosensitive member 3 after transferring of the image.

The intermediate transferring belt 8 is arranged under the photosensitive drums 3, and contacts the photosensitive drums 3. The intermediate transferring belt 8 is rotated in a direction of arrow B illustrated in FIG. 1 by a rotating source (not shown).

First transferring rollers 9 are arranged in an inside of the intermediate transferring belt 8 at an opposite side of the photosensitive members 3, respectively. The first transferring rollers 9 are applied a predetermined bias by a power source (not shown) to transfer toner images on the surface of the photosensitive drums 3 to the circumferential surface of the intermediate transferring belt 8.

Second transferring roller 10 is arranged at an opposite side of a roller supporting the intermediate transferring belt 8, and the transferring roller 10 is applied a predetermined bias by a power source (not shown).

The images respectively formed on the surface of the four photosensitive drums 3 are sequentially transferred to the intermediate transfer belt 8 one above the other in accordance with the rotation of the intermediate transfer belt 8, completing a full-color image on the outer circumferential surface of the intermediate transfer belt 8.

The full-color image is transferred onto a recording media 11 by the predetermined bias of the second transferring roller 10.

A fixing device 12 includes a heating roller 12a and a pressing roller 12b. The fixing device 12 fixes the toner image on the recording media 11 with heat and pressure by using oil-less fusing, which is a fixing device without application an oil, and conveys the recording media to a discharging tray (not shown).

After the secondary image transfer, the intermediate transfer belt cleaning device 13 removes residual toner remaining on the outer circumferential surface of the intermediate transferring belt 8.

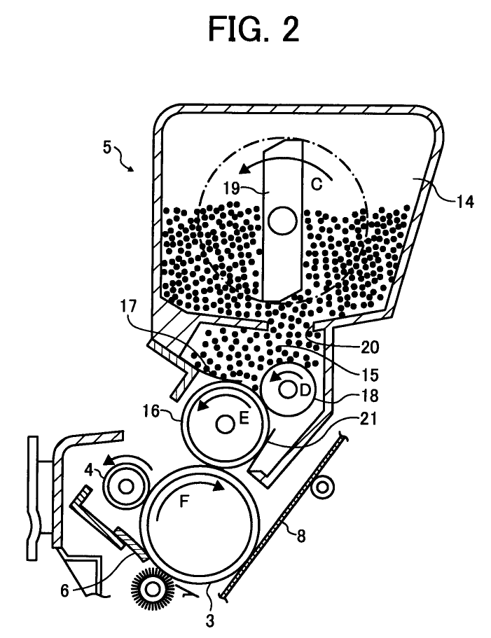

The following describes the developing device 5. As shown in FIG. 2, the developing device 5 includes a toner storing section 14, a toner supply section 15, a developing roller 16, a toner regulating member 17, and a supplying roller 18.

The toner storing section 14 storages non-magnetic monocomponent toner including organic boron compounds.

The developing roller 16 contacts the surface of the photosensitive drum 3, and the developing roller 16 is applied a predetermined developing bias by a power source (not shown).

The storing section 14 includes a toner agitator 19 rotating in a direction of arrow C illustrated in FIG. 2 to provide liquidity to the toner.

Toner is transferred to the toner supplying section 15 through an inlet 20 arranged above the supplying roller 18. The inlet 20 is arranged just above the supplying roller 18, and the inlet 20 has no portion that overlaps the toner regulating member 17 in the vertical direction. A part of the wall partitioning off the toner storaging section 14 and the toner supplying section 15 is installed just above the toner regulating member 17.

Formed materials having cavities are coated on the surface of the supplying roller 18.

The formed materials trap the toner transferred into a toner supplying section 15 effectively. In addition, it prevents deterioration of the toner because of the pressure concentration in the nip between the supplying roller 18 and the developing roller 16.

The formed material is an electro-conductive material containing the carbon particles. The electric resistance of the formed material ranges from 10³ to 10¹³Ω.

The supplying roller 18 is applied the supply bias, which has a voltage offset from the developing bias to the same polarity of the toner.

The toner is pushed by the supply bias toward the developing roller 16.

The supplying roller 18 is rotated in a direction of the arrow D illustrated in FIG. 2 by a rotating source (not shown).

The supplying roller 18 supplies the surface of the developing roller 16 with the toner adhered to the surface of the supplying roller 18.

The developing roller 16 has a rubber layer coated on the surface of the developing roller 16.

A surface coating layer, which is charged with the reverse polarity of the toner, is formed on the surface of the rubber layer.

The rubber layer is set by the JIS-A hardness by the hardness equal to or less than 50 degrees to keep a contact state with the photosensitive drum 3 uniformly, and is set by electric resistance ranging from 10³ To 10¹³Ω.

The surface coating layer is set by Ra by a roughness ranging from 0.2 to 2.0 μm.

The developing roller 16 is rotated in a direction of arrow E illustrated in FIG. 2 by a rotating source (not shown). The developing roller 16 transfers the toner to a developing nip between the developing roller 16 and the photosensitive drum 3.

The toner regulating member 17 is formed by a leaf spring made from metal such as SUS304CSP, SUS301CSP, and phosphor bronze.

One end of the toner regulating member 17 is fixed to a member constituting the toner supplying section 15, and the other end of the toner regulating member 17 contacts the developing roller 16 by applying a pressure of from 10 to 100 N/m.

The regulating member 17 regulates the thickness of the toner on the surface of the developing roller 16, and charges the toner by a frictional charge.

The regulating member 17 is applied a regulate supply bias, which has a voltage offset from the developing bias to the same polarity of the toner.

In this embodiment, the photosensitive drum 3 rotates in the direction of arrow F illustrated in FIG. 2.

The regulating member 17 regulates the thickness of the toner on the surface of the developing roller 16, and the developing roller 16 transfers the toner to a developing nip between the developing roller 16 and the photosensitive drum 3.

The electric latent images are developed by the toner, which is moved by an electric field between the developing bias applied to the developing roller 16 and a potential of the electric latent image on the photosensitive drum 3.

A seal 21 is arranged downstream of the developing nip to prevent the residual toner remaining on the surface of the developing roller 16 from the leaking outside of the development device 5.

The following describes a toner as a developing material for using in this embodiment.

The toner includes at least a first binder resin, a second binder resin, a pigment, a charge controlling agent and an external additive.

The first and second binder resins are not particularly limited, and known binder resins for use in conventional full color toners can be used.

Specific examples thereof include polyester resins, (meth)acrylic resins, styrene-(meth)acrylic copolymers, epoxy resins, cyclic olefin resins (e.g., TOPAS-COC (from Ticona)), etc. Among these resins, polyester resins are preferably used because of their good resistance to stresses applied to the toner in a developing device.

Suitable polyester resins for use in the toner of the present invention include polyester resins that are prepared by subjecting a polyhydric alcohol and a polycarboxylic acid to a polycondensation reaction. Specific examples of dihydric alcohols for use as the polyhydric alcohol include alkylene oxide adducts of bisphenol A such as polyoxypropylene(2,2)-2,2-bis (4-hydroxyphenyl)propane, polyoxypropylene(3,3)-2,2-bis(4-hydroxyphenyl)propane, polyoxypropylene(6)-2,2-bis(4-hydroxyphenyl)propane, and polyoxypropylene(2,0)-2,2-bis (4-hydroxyphenyl)propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polytetramethylene glycol, bisphenol A, hydrogenated bisphenol A, etc. Specific examples of tri- or more hydric alcohols include sorbitol, 1,2,3,6-hexanetetrol, 1,4-sorbitane, pentaerythritol, dipentaerythritol, tripentaerythritol, 1,2,4-butanetriol, 1,2,5-pentanetriol, glycerol, 2-methylpropane triol, 2-methyl1,2,4-butanetriol, trimethylol ethane, trimethylol propane, 1,3,5-trihydroxymethyl benzene, etc.

Specific examples of dicarboxylic acids for use as the polycarboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, iso-dodecenylsuccinic acid, n-octenylsuccinic acid, iso-octenylsuccinic acid, n-octylsuccinic acid, iso-octylsuccinic acid, anhydrides or low alkyl esters of these acids, etc.

Specific examples of tri- or more carboxylic acids for use as the polycarboxylic acid include 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxylic, 1,2,4-cyclohexanetricarboxylic acid, tetra(methylenecarboxy)methane, 1,2,7,8-octanetetracarboxylic acid, pyromellitic acid, trimer acids of embole, anhydrides or low alkyl esters of these acids, etc.

In addition, vinyl-polyester resins which are prepared by mixing monomers of a polyester resin, one or more monomers of a vinyl resin, and one or more monomers which are reactive with both the monomers of the polyester resin and the monomers of the vinyl resin, and subjecting the monomers to a polycondensation reaction (to prepare the polyester resin) and a radical reaction (to prepare the vinyl resin) at the same time can also be used as the polyester resin. The monomers that are reactive with the monomers of the polyester resin and the monomers of vinyl resin are monomers that can be used for both a polycondensation reaction and a radical reaction, i.e., monomers that have both a carboxyl group which can cause a polycondensation reaction and a vinyl group that can cause a radical reaction. Specific examples of such monomers include fumaric acid, maleic acid, acrylic acid, methacrylic acid, etc.

Specific examples of the monomers for use in preparing the polyester component of the vinyl-polyester resins include the polyhydric alcohols and polycarboxylic acids mentioned above. Specific examples of the monomers for use in preparing the vinyl resin component of the vinyl-polyester resins include styrene and derivatives thereof such as styrene, o-methylstyrene, m-methylstyrene, p-methylstyrene, α-methylstyrene, p-ethylstyrene, 2,4-dimethylstyrene, p-tert-butylstyrene, and p-chlorostyrene; ethylene-type unsaturated mono-olefins such as ethylene, propylene, butylene, and isobutylene; alkyl esters of methacrylic acid such as methyl methacrylate, n-propyl methacrylate, isopropyl methacrylate, n-butyl methacrylate, isobutyl methacrylate, t-butyl methacrylate, n-pentyl methacrylate, isopentyl methacrylate, neopentyl methacrylate, 3-(methyl)butyl methacrylate, hexyl methacrylate, octyl methacrylate, nonyl methacrylate, decyl methacrylate, undecyl methacrylate, and dodecyl methacrylate; alkyl esters of acrylic acid such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate, and dodecyl acrylate; unsaturated carboxylic acids such as acrylic acid, methacrylic acid, itaconic acid, and maleic acid; acrylonitrile, esters of maleic acid, esters of itaconic acid, vinyl chloride, vinyl acetate, vinyl benzoate, vinyl methyl ketone, vinyl ethyl ketone, vinyl hexyl ketone, vinyl methyl ether, vinyl ethyl ether, and vinyl isobutyl ether.

Specific examples of the polymerization initiators for use in polymerizing the vinyl monomers include azo-type or diazo-type initiators such as 2,2′-azobis(2,4-dimethylvaleronitrile), 2,2′-azobisisobutylonitirile, 1,1′-azobis(cyclohexane-1-carbonitrile), and 2,2′-azobis-4-methoxy-2,4-dimethylvaleronitrile; and peroxide-type initiators such as benzoyl peroxide, dicumyl peroxide, methyl ethyl ketone peroxide, isopropyl peroxy carbonate, and lauryl peroxide.

The above-mentioned polyester resins are preferably used as the binder resin of the toner of the present invention. In order that the toner can be used for oil-less fixing methods, the toner preferably has a good combination of releasability and offset resistance. In order to impart a good combination of releasability and offset resistance to the toner, a combination of a first binder resin and a second binder resin is used for the binder resin.

Suitable resins for use as the first binder resin include polyester resins, which are prepared by subjecting a polyhydric alcohol and a polycarboxylic acid to a polycondensation reaction, and preferably polyester resins, which are prepared by subjecting an alkylene oxide adduct of bisphenol A (a polyhydric alcohol) and terephthalic acid or fumaric acid (a polycarboxylic acid) to a polycondensation reaction.

Suitable resins for use as the second binder resin include vinyl-polyester resins, and preferably vinyl-polyester resins, which are prepared by using an alkylene oxide adduct of bisphenol A, terephthalic acid, trimellitic acid and succinic acid as monomers for forming a polyester resin component; styrene and butyl acrylate as monomers for forming a vinyl resin component; and fumaric acid as a monomer for use in both the polycondensation reaction and radical polymerization reaction.

It is preferable for a hydrocarbon wax to be internally added during synthesis of the first binder resin in the present invention. In order to internally add hydrocarbon wax to the first binder resin in advance, the synthesis of the first binder resin is performed while hydrocarbon wax is added to the monomer for synthesizing the first binder resin. For example, condensation polymerization may be performed while hydrocarbon wax is added to oxygen monomer and alcohol monomer organizing the polyester resin as the first binder resin. When the first binder resin is a vinyl polyester resin, condensation polymerization and radical polymerization may be performed by allowing basic monomer of vinyl resin to drip while stirring and heating the monomer after hydrocarbon wax is added to the basic monomer of the polyester resin.

Generally, releasing agents (waxes) that are low in polarity excel in releasing ability with a fixing member roller. The wax that is used in the present invention is a hydrocarbon wax, which is low in polarity and it is advantageous in oil-less and low-temperature fixing. It is not limited to these waxes, and the toner with no wax added may also be used. Moreover, high-viscosity wax may be used for improving high-temperature offset or low-molecular wax for improving peeling strength and a wax with which oxidation is adjusted may be used accordingly from the viewpoint of solubility with the resin. A hydrocarbon wax is a wax consisting only of carbon and hydrogen atoms and does not contain an ester group, alcohol group, or amide group. Specific examples of hydrocarbon wax that are internally added to the resin include polyolefin waxes such as polyethylene, polypropylene and copolymer of ethylene and propylene, petroleum waxes such as paraffin wax and microcrystalline wax and synthesized waxes such as Fischer Tropsch wax. Of these, the preferred waxes of the present invention are polyethylene wax, paraffin wax, and Fischer Tropsch wax, and more preferred waxes are polyethylene wax and paraffin wax.

The toner particles of the toner of the present invention can include one or more additives such as charge controlling agents.

Specific examples of the charge controlling agents include organic boron compounds such as LR-147 (from Japan Carlit Co., Ltd.: benzyl acid boron compound).

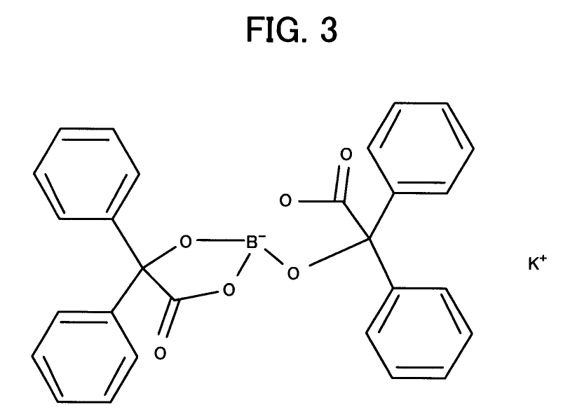

FIG. 3 shows a structural diagram of organic boron compounds.

Specific examples of such pigments include carbon black, Nigrosine dyes, black iron oxide, Naphthol YellowS, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidineorange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussianblue, Anthraquinone Blue, Fast Violet B, Methyl Violet Lake, cobalt violet,manganese violet, dioxane violet, Anthraquinone Violet, ChromeGreen, zincgreen, chromiumoxide, viridian, emeraldgreen, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The content of the pigment is preferably from 1 to 15% by weight, and more preferably from 3 to 10% by weight, based on the total weight of the toner component.

Master batch pigments, which are prepared by combining a pigment with a resin, can be used as the pigment of the toner composition of the present invention.

Specific examples of the resins for use in the master batch pigments or for use in combination with master batch pigments include the polyester resins mentioned above, the vinyl resins mentioned above, rosin, modified rosins, terpene resins, aliphatic or alicyclic hydrocarbon resins, aromatic petroleum resins, chlorinated paraffin, paraffin waxes, etc.

These resins can be used alone or in combination.

The toner particles may be mixed with an external additive to assist in improving the fluidity, developing property and charging ability of the toner particles.

Specific examples of such inorganic particulate materials include silica, alumina, titanium oxide, barium titanate, magnesium titanate, calcium titanate, strontium titanate, zinc oxide, tin oxide, quartz sand, clay, mica, sand-lime, diatomaceous earth, chromium oxide, cerium oxide, red iron oxide, antimony trioxide, magnesium oxide, zirconium oxide, barium sulfate, barium carbonate, calcium carbonate, silicon carbide, silicon nitride, etc.

The following describes a preparation method of the first binder resin.

The following components were mixed in a dropping funnel.

Vinyl monomers

| | |
|---|---|
| Styrene | 600 g |
| Butyl acrylate | 110 g |
| Acrylic acid | 30 g |
| Dicumylperoxide (polymerization initiator) | 30 g |

The following components were contained in a four necked 5-liter flask equipped with a thermometer, a stainless stirrer, a condenser, and a nitrogen feed pipe.

Monomers for polyester resin

| | |
|---|---|
| Polyoxypropylene(2,2)-2,2-bis(4- | 1230 g |
| hydroxylphenyl)propane | |
| Polyoxyethylene(2,2)-2,2-bis(4- | 290 g |
| hydroxylphenyl)propane | |
| Isododecenylsuccinic anhydride | 250 g |
| Terephthalic acid | 310 g |
| 1,2,4-benzenetricarboxylic acid anhydride | 180 g |
| Dibutyl tin oxide (esterification catalyst) | 7 g |

The components in the four-necked flask were heated to 160° C. by a mantle heater while agitated with the stirrer. In addition, the components in the dropping funnel was dropped in the flask over one hour. After the mixture was heated for 2 hours at 160° C. to complete an addition polymerization reaction, the reaction product was heated to 230° C. to perform a polycondensation reaction. The polymerization degree of the reaction product was occasionally checked using a constant-pressure orifice rheometer. When the reaction product had a desired softening point, the polycondensation reaction was ended. Thus, a resin H1 having a softening point (T1/2) of 130° C. was prepared.

The following is a preparation method of the second binder resin.

The following components were contained in a four necked 5-liter flask equipped with a thermometer, a stainless stirrer, a condenser, and a nitrogen feed pipe.

Monomers for polyester resin

| | |
|---|---|
| Polyoxypropylene(2,2)-2,2-bis(4- | 2210 g |
| hydroxylphenyl)propane | |
| Terephthalic acid | 850 g |
| 1,2,4-benzenetricarboxylic acid anhydride | 190 g |
| Dibutyl tin oxide (esterification catalyst) | 0.5 g |

After the mixture was heated 230° C. to perform a polycondensation reaction. The polymerization degree of the reaction product was occasionally checked using a constant-pressure orifice rheometer. When the reaction product had a desired softening point, the polycondensation reaction was ended.

The following describes a preparation of toner particles.

| | |
|---|---|
| First binder resin H1W | 40 parts |
| Second binder resin L1 | 60 parts |
| (prepared above) | |
| C.I. Pigment Red 57-1 | 4 parts |
| (included in a master batch) | |

The mixture was then melted and kneaded with a double-axis kneader PCM-30 from Ikegai Corp., from which a discharging portion of the kneader is detached. The kneaded mixture was then cooled by a press roller so as to have a thickness of 2 mm, followed by cooling with a cooling belt. The cooled mixture was crushed with a feather mill, followed by pulverization with a mechanical pulverizer, KTM from Kawasaki Heavy Industries Ltd., to prepare particles with an average particle diameter of from 10 to 12 μm. Further, the pulverized mixture was pulverized with a jet pulverizer IDS from Nippon Pneumatic Mfg. Co., Ltd. while coarse particles were removed. Furthermore, the pulverized mixture was subjected to a fine particle classification using a rotor classifier TURBOPLEX 100 ATP from Hosokawa Micron Corp. One hundred (100) parts by weight of the thus prepared toner particles were mixed with a predetermined part by weight of a silica RX200. In this case, mixing was performed for 60 seconds using a HENSCHEL MIXER mixer in which the tip of the blade is rotated at a peripheral speed of 40 m/sec. Thus, a magenta toner was prepared.

As described above, any portion of the inlet 20 arranged above the toner supplying roller 18, where toner is transferred from the toner storaging section 14 to the toner supplying section 15 through, is not overlapping the regulating member 17 in the vertical direction.

Thus, it can be easy to secure the flow of the toner to face the supplying roller 18, and the toner of enough quantity can be sent to the toner supplying section 15. In addition, the gravity of toner in the toner storage section 14 does not act on the regulating member 17 neighborhoods, thus surplus toner which does not pass a nip between the toner regulating member 17 and the developing roller 16 can move easily in the whole toner supplying section 15.

When the developer includes organic boron compounds, a charging property of the developer may be stable and a flow of the developer may be improved. Thus, it can prevent an agglomeration and an adhesion of the developer.

When the supplying roller 18 comprises a roller that is coated on the surface with formed material and pressed to the photosensitive member, the developer transportation power in the surface of the supplying roller 18 increases.

Thus, the supplying roller 18 can increase the developer flow, and can prevent an agglomeration and an adhesion of the developer due to the accumulation of the developer.

The developing device 5 is detachable from a body of the image forming apparatus 1 as a process cartridge 2. Thus, the image forming apparatus 1 is easier to maintain.

A two-component developer, in which 5 parts of a toner and 95 parts of a silicone-coated carrier are mixed, is set in a modified full-color printer IPSION CX7500 (manufactured and modified by Ricoh Co., Ltd.) from which the fixing device is detached. The modified full-color printer is adjusted so that a solid image having 1.0 to 1.2 μg/cm2 of the toner thereon is developed on a paper having a cross direction (TYPE 6200 from Ricoh Co., Ltd.) at a position of 3 mm behind the tip thereof while the paper is fed in the vertical direction, and 6 sheets of the paper having an unfixed image thereon are produced.

Eight kinds of toner, which have a content of the charge controlling agent of 0.4 parts by weight to 3.5 parts by weight relative to 100 parts by weight of the toner, and a content of the external additive of 1.0 parts by weight to 4.5 parts by weight relative to 100 parts by weight of the toner is used.

The fixing device detached from a full-color printer IPSIO CX2500 (manufactured by Ricoh Co., Ltd.) was modified so that the temperature and the linear speed of the fixing belt are variable. Each of the unfixed images prepared above is fixed from the tip portion (i.e., 3 mm-wide margin) thereof using the modified fixing device at a linear speed of 125 mm/sec and a temperature of from 140 to 190° C. in increments of 10°, respectively. The separativeness is evaluated by the number of sheets in which the unfixed image is normally fixed without occurrence of problems that a paper is wound around the fixing belt, a paper is jammed like an accordion at the exit of the fixing device, etc.

The results are shown in Table 1.

TABLE 1

| | Added amount of a charge | Added amount of an | |
|---|---|---|---|
| | controlling agent | external additive | Separetiveness |
| Toner | (parts by weight) | (parts by weight) | in oilless fixing |
| A | 0.5 | 2.5 | Very good |
| B | 3.0 | 2.5 | Very good |
| C | 2.0 | 1.5 | Very good |
| D | 2.0 | 4.0 | Good |
| E | 0.4 | 2.5 | Very Good |
| F | 3.5 | 2.5 | Very Good |
| G | 2.0 | 1.0 | Very Good |
| H | 2.0 | 4.5 | Bad |

Very good: 6 sheets are normally fixed
Good: 3 to 5 sheets are normally fixed
Bad: 2 or less sheets are normally fixed

A running test in which 8,000 sheets of a printing pattern having a printing proportion of 15% are continuously produced is performed with the image forming apparatus 1 illustrated in FIG. 1. The image forming apparatus includes the above described eight kinds of toner of 180 g in the developer storaging section 14 (filled up about 80% of the developer storaging section).

After the running test, the regulating member, the developing roller, and the image produced were visually observed and evaluated as follows.

The results were shown in Table 2.

TABLE 2

| | Added | Added | | | |
|---|---|---|---|---|---|
| | amount of a | amount | | | |
| | charge | of an | | | |
| | controlling | external | Streak on | | |
| | agent | additive | the | Fog of the | Filming on |
| | (parts by | (parts by | regulating | developing | developing |
| Toner | weight) | weight) | member | device | roller |
| A | 0.5 | 2.5 | Good | Good | Good |
| B | 3.0 | 2.5 | Very good | Good | Good |
| C | 2.0 | 1.5 | Good | Good | Good |
| D | 2.0 | 4.0 | Very good | Good | Good |
| E | 0.4 | 2.5 | Bad | Good | Good |
| F | 3.5 | 2.5 | Very good | Bad | Good |
| G | 2.0 | 1.0 | Bad | Good | Good |
| H | 2.0 | 4.5 | Very good | Good | Bad |

Streak on
Very good: No streak is observed on the regulating member.
Good: Streak is observed on the regulating member, but no striped pattern is observed in the image product.
Bad: striped pattern is observed in the image product.
Fog of the developing device
Good: No fog is observed in the image product.
Bad: Fog is observed in the image product.
Filming on the developing roller
Good: No filming is observed on the developing roller.
Bad: Filming is observed on the developing roller.

As described above, when the toner includes a charge controlling agent, of which content is 0.5 parts by weight to 3.0 parts by weight relative to 100 parts by weight of the toner, and an external additive, of which content is 1.5 parts by weight to 4.0 parts by weight relative to 100 parts by weight of the toner, separetiveness in oilless fixing, it can improve streak on the regulating member, fog of the developing device and filming on developing roller.

An average circularity of the toner used in the above-mentioned image forming apparatus is varied. In the case of an average circularity of the toner is less than 0.880, the toner has not enough flow property.

In the case of an average circularity of the toner is more than 0.970, the toner that is not removed by the cleaning device is observed on the surface of the photosensitive member.

Thus, when the toner has the average circularity of from 0.880 to 0.970, it can form good image products.

A content of the wax in the toner used in the above-mentioned image forming apparatus is varied. When the content of the wax is less than 3 parts by weight relative to 100 parts by weight of the resin, an amount of melted wax is not enough so that the separetiveness of the toner is not enough and the jam at the fixing device occurs.

When the content of the wax is more than 10 parts by weight relative to 100 parts by weight of the resin, the flow property of the toner deteriorates because the amount of wax exposed on the surface of the toner is too much. Then, it is observed that the image quality decreases remarkably because the transfer efficiency decreases, and the developing device 5 and the photosensitive member 3 are polluted. Thus, when the content of the wax is 3 parts by weight to 10 parts by weight relative to 100 parts by weight of the resin, it can improve the image quality.

A content of the volume average particle diameter of the toner is varied.

A volume-average particle diameter less than 5 μm tends to cause an excessive charging (charge-up) of the toner, thus undesirably generating a negative ghost.

Also a volume-average particle diameter exceeding 10 μm results in an undesirable image lacking high definition. Thus, when the toner has a volume average particle diameter of from 5 μm to 10 μm, it can improve the image quality.

In addition, when a wax dispersing agent is added to the toner, a dispersibility of the wax in the toner is improved, and it becomes possible to better form the image.

The preceding discussion has assumed a tandem type color image forming apparatus as an example of an image forming apparatus, but the present invention is not limited only to such a tandem type color image forming apparatus.

For example, an embodiment can be a printer, a facsimile machine, or a multi-function machine that includes a fixing device.

What is claimed as new and desired to be secured by Letters Patent of the United State is:

1. A developing device that develops latent images on a surface of a photosensitive member in an image forming apparatus, comprising:
a developer bearing member arranged in close proximity to or contacting the surface of the photosensitive member;
a developer supplying member arranged in a developer supplying section and configured to supply the surface of the photosensitive member with developer;
a developer storing section arranged above the developer supplying section and configured to store the developer;
an inlet, arranged above the developer supplying member, through which developer is transferred from the developer storing section to the developer supplying section; and
a developer regulating member configured to regulate the thickness of the developer on a surface of the developer bearing member,
wherein no portion of the inlet overlaps the developer regulating member in a vertical direction.

2. The developing device according to claim 1, wherein the developer supplying member comprises a developer supplying roller having a surface coated on the surface with formed material, the developer supplying rolling configured to press against the photosensitive member.

3. The developing device according to claim 1, wherein the developer is a non-magnetic mono-component toner including organic boron compounds.

4. The developing device according to claim 3, wherein the developer comprises a resin added to a hydrocarbon wax.

5. The developing device according to claim 3, wherein the developer comprises a resin added to a hydrocarbon wax, a pigment, a charge controlling agent, and an external additive.

6. The developing device according to claim 5, wherein a content of the charge controlling agent is 0.5 parts by weight to 3.0 parts by weight relative to 100 parts by weight of the toner, and a content of the external additive is 1.5 parts by weight to 4.0 parts by weight relative to 100 parts by weight of the toner.

7. The developing device according to claim 4, wherein a content of the wax is 3 parts by weight to 10 parts by weight relative to 100 parts by weight of the resin.

8. The developing device according to claim 3, wherein the toner has an average circularity of 0.880 to 0.970.

9. The developing device according to claim 3, wherein the toner has a volume average particle diameter of 5 μm to 10 μm.

10. The developing device according to claim 3, wherein the toner includes a wax dispersing agent.

11. A process cartridge configured to be detachably mounted in an image forming apparatus, comprising:
a developing device configured to develop latent images on a surface of a photosensitive member;
a developer bearing member arranged in close proximity to or contacting the surface of the photosensitive member;
a developer supplying member arranged in a developer supplying section and configured to supply the surface of the photosensitive member with developer;
a developer storing section arranged above the developer supplying section and configured to store the developer;
an inlet, arranged above the developer supplying member, through which developer is transferred from the developer storing section to the developer supplying section;
a developer regulating member configured to regulate the thickness of the developer on the surface of the developer bearing member,
wherein no portion of the inlet overlaps the regulating member in a vertical direction.

12. The developing device according to claim 11, wherein the developer is non-magnetic monocomponent toner including a resin added to a hydrocarbon wax, a pigment, a charge controlling agent, and an external additive.

13. The developing device according to claim 12, wherein a content of the charge controlling agent is 0.5 parts by weight to 3.0 parts by weight relative to 100 parts by weight of the toner, and
a content of the external additive is 1.5 parts by weight to 4.0 parts by weight relative to 100 parts by weight of the toner.

14. The developing device according to claim 11, further comprising the photosensitive member.

15. An image forming apparatus, comprising:
a developing device configured to develop latent images on a surface of a photosensitive member;
a developer bearing member arranged in close proximity to or contacting the surface of the photosensitive member;
a developer supplying member arranged in a developer supplying section and configured to supply the surface of the photosensitive member with developer;
a developer storing section arranged above the developer supplying section and configured to store the developer;
an inlet, arranged above the developer supplying member, through which developer is transferred from the developer storing section to the developer supplying section; and
a developer regulating member configured to regulate a thickness of the developer on a surface of the developer bearing member,
wherein no portion of the inlet overlaps the regulating member in a vertical direction.

16. The image forming apparatus according to claim 15, wherein the developer is non-magnetic monocomponent toner including a resin added to a hydrocarbon wax, a pigment, a charge controlling agent, and an external additive.

17. The image forming apparatus according to claim 16, wherein a content of the charge controlling agent is 0.5 parts by weight to 3.0 parts by weight relative to 100 parts by weight of the toner, and
a content of the external additive is 1.5 parts by weight to 4.0 parts by weight relative to 100 parts by weight of the toner.

18. The image forming apparatus according to claim 15, further comprising:
a fixing device including a heating roller and a pressing roller.

19. The image forming apparatus according to claim 15, further comprising an oil-less fixing device that does not require application of an oil.
